(19) United States
(12) Patent Application Publication
(10) Pub. No.: US 2012/0086753 A1
(43) Pub. Date: Apr. 12, 2012

(54) LIQUID EJECTING APPARATUS AND LIQUID EJECTING METHOD

(75) Inventor: Kazuaki Sakurada, Suwa-shi (JP)

(73) Assignee: Seiko Epson Corporation, Tokyo (JP)

(21) Appl. No.: 13/271,017

(22) Filed: Oct. 11, 2011

(30) Foreign Application Priority Data
Oct. 12, 2010 (JP) 2010-229865

(51) Int. Cl. B41J 2/21

(52) U.S. Cl. 347/43

(57) ABSTRACT

A liquid ejecting apparatus including a group of first nozzle rows composed of a plurality of first nozzle rows and a group of second nozzle rows composed of a plurality of second nozzle rows, both the group of first nozzle rows and the group of second nozzle rows satisfying one of the following requirements (1) through (3): (1) a black nozzle row is included, (2) a yellow nozzle row, a magenta nozzle row and a cyan nozzle row are all included, and (3) the secondary color nozzle row for the secondary color made by mixing any two of yellow, magenta and cyan, and at least one of the nozzle row that ejects liquid of the remaining one of yellow, magenta and cyan and the secondary color nozzle row for the secondary color which includes the remaining one of yellow, magenta and cyan are included.

### INCORPORATION BY REFERENCE

This application claims the benefit of Japanese Patent Application No. 2010-229865, filed on Oct. 12, 2010, which is hereby incorporated by reference herein in its entirety.

### BACKGROUND

1. Technical Field

The present invention relates to liquid ejecting apparatuses and liquid ejecting methods.

2. Related Art

Liquid ejecting apparatuses such as ink jet printers are already well known. Such liquid ejecting apparatuses have a head, which may be provided with a plurality of first nozzle rows composed of nozzles arranged at corresponding positions in the row direction in all the plurality of first nozzle rows and a plurality of second nozzle rows composed of nozzles arranged at corresponding positions in the row direction in all the plurality of second nozzle rows and offset in the row direction from the nozzle positions of the plurality of first nozzle rows. Further, the head may be configured such that each of the plurality of first nozzle rows and the plurality of second nozzle rows includes different nozzle rows selected from a first color nozzle row that ejects a first primary color liquid onto a medium, a second color nozzle row that ejects a second primary color liquid onto the medium, a third color nozzle row that ejects a third primary color liquid onto the medium, a black nozzle row that ejects a black liquid onto the medium, and a secondary color nozzle row that ejects at least one secondary color liquid onto the medium. JP-A-2010-73652 is an example of related art.

When liquid is ejected onto the medium using the head, unevenness of the colors may occur due to expansion and/or contraction of the medium. The unevenness of the colors which is noticeable causes the deterioration of image quality.

### SUMMARY

An advantage of some aspects of the invention is that the deterioration of image quality is reduced.

According to a main aspect of the invention, the following liquid ejecting apparatus is provided: a liquid ejecting apparatus having a head which is provided with a plurality of first nozzle rows composed of nozzles arranged at corresponding positions in the row direction in all the plurality of first nozzle rows and a plurality of second nozzle rows composed of nozzles arranged at corresponding positions in the row direction in all the plurality of second nozzle rows and offset in the row direction from the nozzle positions of the plurality of first nozzle rows, each of the plurality of first nozzle rows and the plurality of second nozzle rows including different nozzle rows selected from a first color nozzle row that ejects a first primary color liquid onto a medium, a second color nozzle row that ejects a second primary color liquid onto the medium, a third color nozzle row that ejects a third primary color liquid onto the medium, a black nozzle row that ejects a black liquid onto the medium, and a secondary color nozzle row that ejects at least one secondary color liquid onto the medium, the liquid ejecting apparatus including a group of first nozzle rows composed of the plurality of first nozzle rows and a group of second nozzle rows composed of the plurality of second nozzle rows, wherein both the group of first nozzle rows and the group of second nozzle rows satisfying one of the following requirements (1) through (3): (1) the black nozzle row is included, (2) the yellow nozzle row, the magenta nozzle row and the cyan nozzle row are all included, and (3) the secondary color nozzle row for the secondary color made by mixing any two of yellow, magenta and cyan, and at least one of the nozzle row that ejects liquid of the remaining one of yellow, magenta and cyan onto the medium and the secondary color nozzle row for the secondary color which includes the remaining one of yellow, magenta and cyan are included. The other characteristics of the invention will be apparent from the description herein and the accompanying drawings.

### BRIEF DESCRIPTION OF THE DRAWINGS

The invention will be described with reference to the accompanying drawings, wherein like numbers reference like elements.

FIG. 1 is a schematic front view of a printer.

FIG. 2 is a perspective view of an appearance of the printer.

FIG. 3 is a block diagram of an overall configuration of the printer.

FIG. 4 is an explanatory view illustrating a nozzle array which is disposed on an underside of a head.

FIG. 5 is an explanatory view explaining a problem which may occur during printing performed by the head according to an embodiment of the invention.

FIG. 6 is a conceptual view showing that a continuous paper sheet expands and/or contracts in a sheet width direction.

### DESCRIPTION OF EXEMPLARY EMBODIMENTS

The description herein and the accompanying drawings will describe at least the following: a liquid ejecting apparatus having a head which is provided with a plurality of first nozzle rows composed of nozzles arranged at corresponding positions in the row direction in all the plurality of first nozzle rows and a plurality of second nozzle rows composed of nozzles arranged at corresponding positions in the row direction in all the plurality of second nozzle rows and offset in the row direction from the nozzle positions of the plurality of first nozzle rows, each of the plurality of first nozzle rows and the plurality of second nozzle rows including different nozzle rows selected from a first color nozzle row that ejects a first primary color liquid onto a medium, a second color nozzle row that ejects a second primary color liquid onto the medium, a third color nozzle row that ejects a third primary color liquid onto the medium, a black nozzle row that ejects a black liquid onto the medium, and a secondary color nozzle row that ejects at least one secondary color liquid onto the medium, the liquid ejecting apparatus including a group of first nozzle rows composed of the plurality of first nozzle rows and a group of second nozzle rows composed of the plurality of second nozzle rows, both the group of first nozzle rows and the group of second nozzle rows satisfying one of the following requirements (1) through (3): (1) the black nozzle row is included, (2) the yellow nozzle row, the magenta nozzle row and the cyan nozzle row are all included, and (3) the secondary color nozzle row for the secondary color made by mixing any two of yellow, magenta and cyan, and at least one of the nozzle row that ejects liquid of the remaining one of yellow, magenta and cyan onto the medium and the secondary color nozzle row for the secondary color which includes the remaining one of yellow, magenta and cyan are included. With this configuration, the liquid ejecting apparatus is capable of reducing the deterioration of image quality.

The liquid ejecting apparatus may include a support member that supports and heats the medium in a state of contact with the medium. With this configuration, the deterioration of image quality can be more effectively reduced.

The description herein and the accompanying drawings will further describe the following: a liquid ejecting method for ejecting liquid onto a medium for use with a liquid ejecting apparatus having a head which is provided with a plurality of first nozzle rows composed of nozzles arranged at corresponding positions in the row direction in all the plurality of first nozzle rows and a plurality of second nozzle rows composed of nozzles arranged at corresponding positions in the row direction in all the plurality of second nozzle rows and offset in the row direction from the nozzle positions of the plurality of first nozzle rows, each of the plurality of first nozzle rows and the plurality of second nozzle rows including different nozzle rows selected from a first color nozzle row that ejects a first primary color liquid onto the medium, a second color nozzle row that ejects a second primary color liquid onto the medium, a third color nozzle row that ejects a third primary color liquid onto the medium, a black nozzle row that ejects a black liquid onto the medium, and a secondary color nozzle row that ejects at least one secondary color liquid onto the medium, the liquid ejecting apparatus including a group of first nozzle rows composed of the plurality of first nozzle rows and a group of second nozzle rows composed of the plurality of second nozzle rows, wherein both the group of first nozzle rows and the group of second nozzle rows satisfying one of the following requirements (1) through (3): (1) the black nozzle row is included, (2) the yellow nozzle row, the magenta nozzle row and the cyan nozzle row are all included, and (3) the secondary color nozzle row for the secondary color made by mixing any two of yellow, magenta and cyan, and at least one of the nozzle row that ejects liquid of the remaining one of yellow, magenta and cyan onto the medium and the secondary color nozzle row for the secondary color which includes the remaining one of yellow, magenta and cyan are included. With this configuration, the deterioration of image quality can be more effectively reduced.

### Exemplary Configuration of the Printer

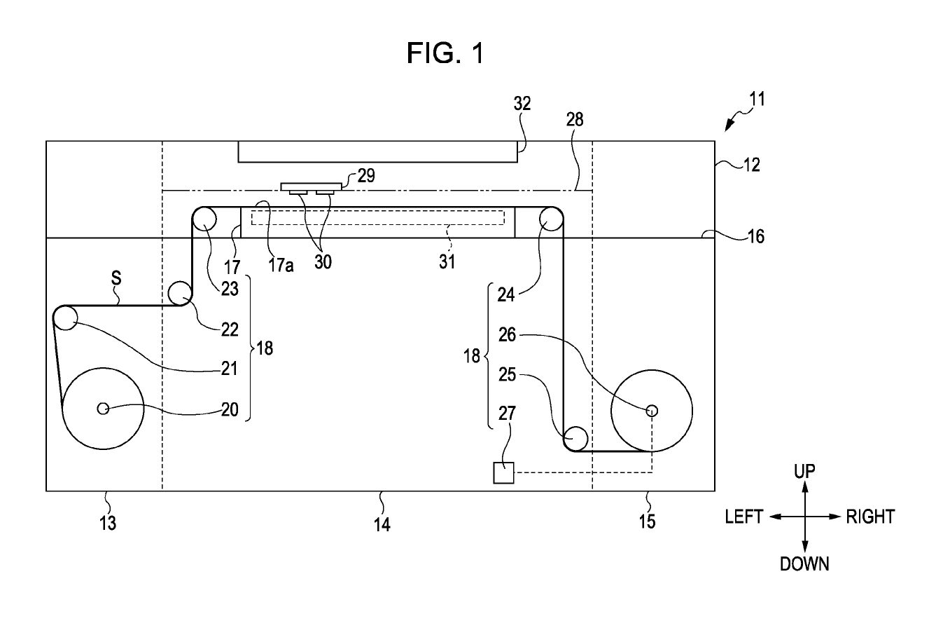

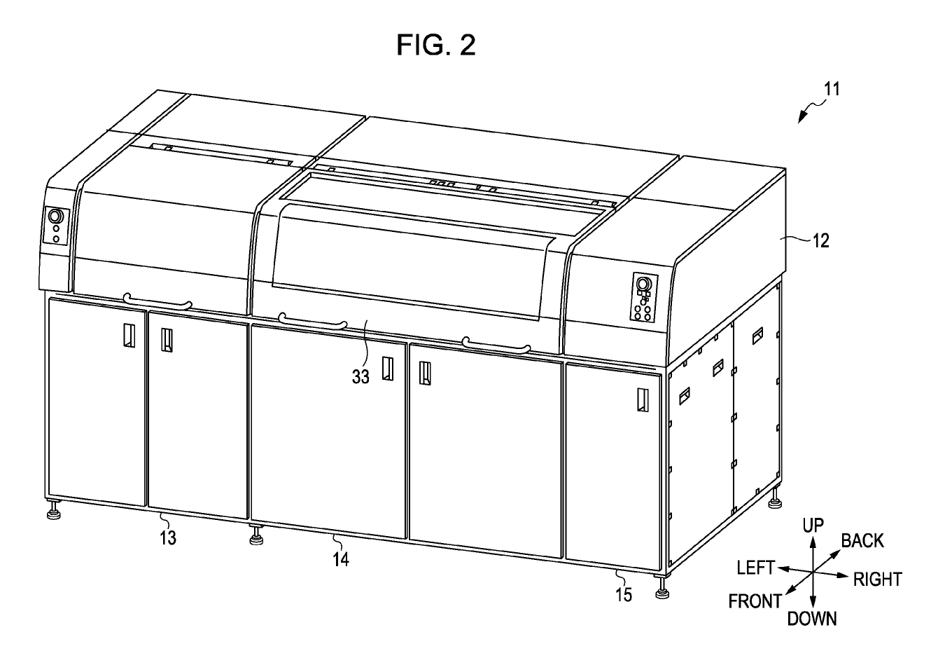

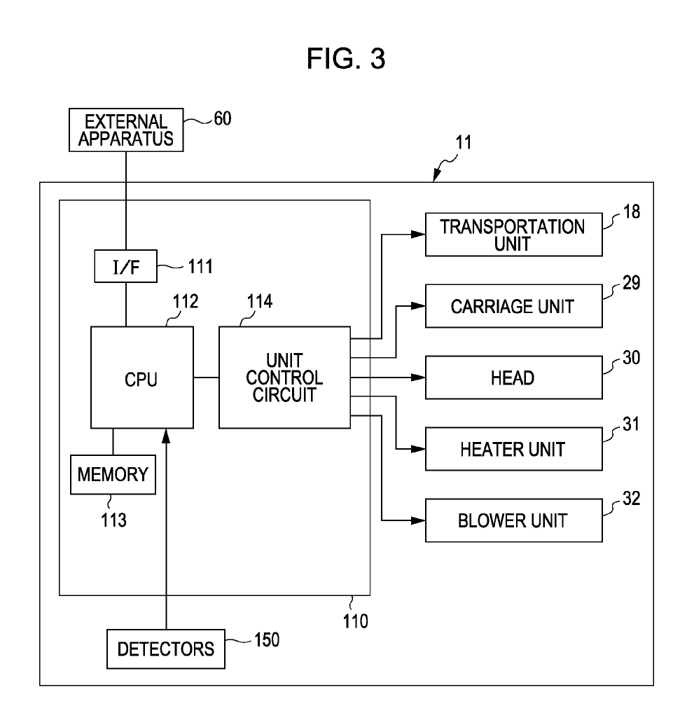

A recording apparatus of the invention which is embodied as a lateral-type ink jet printer will be described below with reference to FIG. 1 to FIG. 6. FIG. 1 is a schematic front view of a printer 11. FIG. 2 is a perspective view of an appearance of the printer 11. FIG. 3 is a block diagram of an overall configuration of the printer 11. The terms “front-back direction,” “left-right direction” and “up-down direction” as used herein refer to the directions shown by the arrows in FIGS. 1 and 2.

As shown in FIG. 1, the printer 11 as a recording apparatus includes a cuboid body case 12. The body case 12 is roughly divided into three sections in the left-right direction, that is, a feed-out section 13, a printing section 14 and a take-up section 15 from left to right. A flat plate-shaped base 16 which separates the body case 12 into upper and lower portions is provided in the body case 12 at a position slightly above the center in the up-down direction.

A platen 17 which is a support member of a rigid material formed in a rectangular plate shape is mounted on the base 16 at a position corresponding to the printing section 14. Further, a transportation unit 18 is housed in the body case 12 so as to transport a continuous paper sheet S as an example of an elongated medium.

The transportation unit 18 includes a winding rod 20 which extends in the front-back direction, rollers 21 to 25, a take-up shaft 26 and a transportation motor 27 configured to rotate the take-up shaft 26. The winding rod 20 and the roller 21 are located within the feed-out section 13, the rollers 22 to 25 and the transportation motor 27 are located within the printing section 14, and the take-up shaft 26 is located within the take-up section 15.

The continuous paper sheet S runs over the rollers 21 to 25 with the left end thereof being wound around the winding rod 20 and the right end thereof being wound around the take-up shaft 26. As the transportation motor 27 rotates, the continuous paper sheet S is slidably moved along the top surface of the platen 17 which serves as a support surface 17a so that the continuous paper sheet S is transported from the feed-out section 13 to the take-up section 15.

A pair of guide rails 28 (indicated by the double-dotted and dashed line in FIG. 1) extends in the left-right direction in the printing section 14 on both sides of the platen 17 in the front-back direction. The top surface of each guide rail 28 is above the top surface of the platen 17 and the top surface of guide rails 28 supports a carriage unit 29 having a rectangular shape so that the carriage unit 29 is movable along the guide rails 28 in a reciprocating manner in the left-right direction (a transportation direction in which the continuous paper sheet S is transported and its reverse direction) by means of a drive mechanism, which is not shown. Further, the carriage unit 29 is also movable in a reciprocating manner in a direction perpendicular to the left-right direction, that is, in the front-back direction by means of a drive mechanism, which is not shown. The head 30 is mounted on the underside of the carriage unit 29.

An area from the left end to the right end of the platen 17 serves as a recording area and the continuous paper sheet S is intermittently advanced by a distance equal to the length of the recording area. During such intermittent advancement, when the continuous paper sheet S stops after being advanced by a distance equal to the length of the recording area, the carriage unit 29 reciprocates (moves in the left-right direction and the front-back direction) over the platen 17, while ink as an example of liquid is ejected through the nozzles on the underside of the head 30, thereby performing recording on the continuous paper sheet S. The configuration of the nozzles disposed on the underside of the head 30 will be described later in detail.

A heater unit 31 for heating the support surface 17a is housed under the support surface 17a of the platen 17. The heat from the heater unit 31 is transferred to the continuous paper sheet S via the support surface 17a and works to dry the ink deposited on the continuous paper sheet S. That is, when being in contact with the continuous paper sheet S, the platen 17 supports the continuous paper sheet S while heating the continuous paper sheet S. Further, a blower unit 32 is disposed above the platen 17 and the carriage unit 29.

An openable cover 33 is provided on the upper part of the body case 12 at the position corresponding to the printing section 14 and a blower unit 32 is mounted on the cover 33. The cover 33 is configured in a closed state to cover the platen 17 that transports the continuous paper sheet S.

Next, referring to FIG. 3, a control configuration of the printer 11 according to this embodiment will be described. When receiving print instructions (print data) from an external apparatus 60, the printer 11 controls each of the units (the transportation unit 18, the carriage unit 29, the head 30, the heater unit 31 and the blower unit 32) through a controller 110 so that images are recorded on the continuous paper sheet S. Further, a group of detectors 150 monitors the internal state of the printer 11 to control each of the units through the controller 110 on the basis of the detection result.

The controller 110 is a control unit that controls the printer 11. An interface 111 transmits and/or receives the data between the external apparatus 60 and the printer 11. A CPU 112 is a processing unit that controls the entire printer 11. A memory 113 secures areas such as an area for storing programs of the CPU 112 and a working area. The CPU 112 controls each of the units through a unit control circuit 114 according to the programs stored in the memory 113.

### Exemplary Nozzle Configuration of the Head

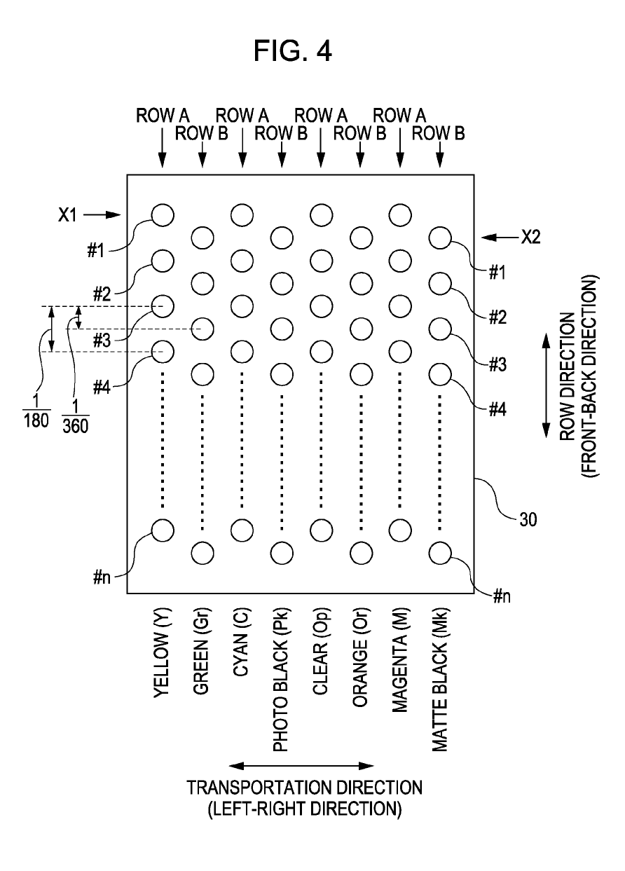

FIG. 4 is an explanatory view illustrating a nozzle array which is disposed on the underside of the head 30. The head 30 is provided with eight nozzle rows, each of which is composed of n nozzles arranged in the front-back direction. That is, the head 30 is provided with the following nozzles as the eight nozzle rows: a yellow (Y) nozzle row that ejects yellow ink onto the continuous paper sheet S, a green (Gr) nozzle row that ejects green ink onto the continuous paper sheet S, a cyan (C) nozzle row that ejects cyan ink onto the continuous paper sheet S, a photo black (Pk) nozzle row that ejects photo black ink onto the continuous paper sheet S, a clear (Op) nozzle row that ejects clear ink onto the continuous paper sheet S, an orange (Or) nozzle row that ejects orange ink onto the continuous paper sheet S, a magenta (M) nozzle row that ejects magenta ink onto the continuous paper sheet S, and a matte black (Mk) nozzle row that ejects matte black ink onto the continuous paper sheet S. Those nozzle rows are arranged in the transportation direction (the left-right direction) as shown in FIG. 4, in the above-described sequence.

The above eight nozzle rows are divided into two groups of nozzle rows (hereinafter, referred to as rows A and rows B) on the basis of the difference in the positions of the nozzles of the nozzle row in the row direction. Specifically, as shown in FIG. 4, the group of rows A (which corresponds to first nozzle rows) includes the yellow (Y) nozzle row, the cyan (C) nozzle row, the clear (Op) nozzle row and the magenta (M) nozzle row. In a plurality of (four) rows A, the nozzles are arranged at corresponding positions in the row direction in all the plurality of (four) rows A (for example, the positions of #1 nozzles in the row direction in the respective nozzle rows A are indicated by X1 as shown in FIG. 4). On the other hand, the group of rows B (which corresponds to a second nozzle rows) includes the green (Gr) nozzle row, the photo black (Pk) nozzle row, the orange (Or) nozzle row and the matte black (Mk) nozzle row. In a plurality of (four) rows B, the nozzles are arranged at corresponding positions in the row direction in all the plurality of (four) rows B (for example, the positions of #1 nozzles in the row direction in the respective nozzle rows A are indicated by X2 as shown in FIG. 4). Moreover, the nozzle positions in the row direction in the rows B are offset from the nozzle positions in the row direction in the rows A (for example, the positions of #1 nozzles in the row direction in the rows A are indicated by X1, while the positions of #1 nozzles in the rows B are indicated by X2).

As mentioned above, the head 30 according to this embodiment is provided with the plurality of (four) rows A in which nozzles are arranged at corresponding positions in the row direction in all the plurality of (four) rows A, and the plurality of (four) rows B in which nozzles are arranged at corresponding positions in the row direction in all the plurality of (four) rows B and are offset in the row direction from the nozzle positions of the rows A, each of the plurality of (four) rows A and the plurality of (four) rows B including different nozzle rows selected from the yellow (Y) nozzle row that ejects yellow ink among the primary color inks onto the continuous paper sheet S, the magenta (M) nozzle row that ejects magenta ink among the primary color inks onto the continuous paper sheet S, the cyan (C) nozzle row that ejects cyan ink among the primary color inks onto the continuous paper sheet S, the black nozzle row (in this embodiment, the photo black nozzle row (Pk) and the matte black nozzle row (Mk)) that eject black ink (in this embodiment, photo black ink and matte black ink) onto the continuous paper sheet S, the secondary color nozzle row (in this embodiment, two nozzle rows, i.e., the orange (Or) nozzle row and the green (Gr) nozzle row) that ejects at least one secondary color ink (in this embodiment, orange ink made by mixing magenta and yellow, and green ink made by mixing cyan and yellow) onto the continuous paper sheet S. Specifically, the nozzle rows of the rows A include the yellow (Y) nozzles row, the cyan (C) nozzle row, the clear (Op) nozzle row and the magenta (M) nozzle row, while the nozzle rows of the rows B include the green (Gr) nozzle row, the photo black (Pk) nozzle row, the orange (Or) nozzle row and the matte black (Mk) nozzle row.

In this embodiment, as shown in FIG. 4, the nozzle rows of the rows A and the nozzle rows of the rows B are alternately arranged in the transportation direction (the left-right direction) and the nozzles of the row B are positioned at the center between adjacent nozzles of the rows A in the row direction (specifically, as shown in FIG. 4, the distance between adjacent nozzles is 1/180 inch and the nozzles of the rows B are offset from the nozzles of the rows A by 1/360 inch). Accordingly, the nozzles are arranged in a staggered fashion on the head 30 according to this embodiment.

### Problem Which may Occur during Printing Performed by the Head

Next, a problem which may occur during printing performed by the head 30 will be described. As mentioned above, the printer 11 according to this embodiment has the head 30 which is provided with the rows A and the rows B whose nozzle positions are offset from each other. The controller 110 moves the head 30 in the transportation direction (the left-right direction) while ejecting ink through the nozzles, thereby forming raster lines along the transportation direction (the left-right direction), thereby performing printing.

In this embodiment, since the nozzle positions in the row direction in the rows B are offset from the nozzle positions in the row direction in the rows A, the ink ejected from the rows A and the ink ejected from the rows B are not superimposed with each other during a single movement (which is referred to as a “pass”) of the head 30 in the transportation direction (the left-right direction) in which ink is ejected from the nozzles (in other words, superimposition of the colors of the rows A and the colors of the rows B are not achieved during one pass). Accordingly, two passes are required for superimposition of ink colors of the ink ejected from the rows A and ink colors of the ink ejected from the rows B (in other words, once the first pass is completed, the head 30 is moved in the row direction (the front-back direction) before executing the second pass.)

The number of passes is not limited to two passes, and for example, four passes or eight passes may be sometimes required to form images. In such a case, a print resolution in the row direction is improved (as the number of passes increases). Specifically, image forming techniques such as a well-known band printing and interlace (microweave) printing are used.

In the following description of a problem which may occur during printing performed by the head 30, the example is described by using two passes (less number of passes) for clarity of explanation (four passes or eight passes may have the same problem regardless of the type of image forming technique used).

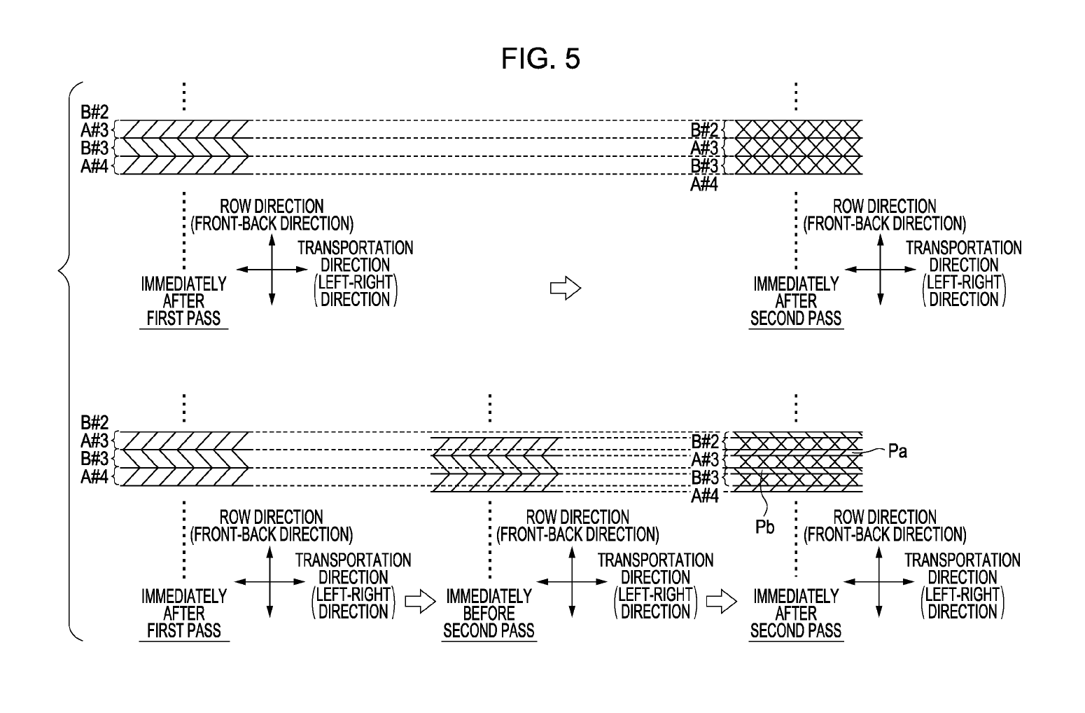

FIG. 5 is an explanatory view explaining a problem. The upper figures show an example where no problem has occurred, and the lower figures show an example where a problem has occurred. The upper left figure shows that the first pass has been made, that is, raster lines are formed during the first pass in which ink is ejected from the nozzles. The raster lines are indicated by elongated strips extending in the left-right direction which is hatched with diagonal lines. The strips hatched with lower left to upper right diagonal lines represent raster lines formed by ejecting ink from the nozzles of four rows A (in this embodiment, the yellow (Y) nozzle row, the cyan (C) nozzle row, the clear (Op) nozzle row and the magenta (M) nozzle row) (hereinafter also referred to as “row A raster lines” for convenience), while the strips hatched with upper left to lower right diagonal lines represent raster lines formed by ejecting ink from the nozzles of four rows B (in this embodiment, the green (Gr) nozzle row, the photo black (Pk) nozzle row, the orange (Or) nozzle row and the matte black (Mk) nozzle row) (hereinafter also referred to as “row B raster lines” for convenience). Each raster line is referenced with the nozzle number of the nozzle that forms the raster line, which is indicated at the left side thereof (for example, A#3 represents the No. 3 nozzle of the row A). Accordingly, the row A raster lines and the row B raster lines are alternately arranged in the row direction (front-back direction) with intervals of 1/360 inch in the first pass.

Then, the controller 110 displaces the head 30 in the row direction (front-back direction) by 1/360 inch before executing the second pass. The upper right figure shows that the second pass has been made, that is, raster lines are formed during the second pass in which ink is ejected from the nozzles. Since the head 30 is displaced in the row direction (front-back direction) by 1/360 inch in the second pass, the raster line formed by ejecting ink from the No. 3 nozzle of the row A during the first pass (hereinafter referred to as A#3 raster line of the first pass) is superimposed by the raster line formed by ejecting ink from the No. 2 nozzle of the row B (hereinafter referred to as B#2 raster line of the second pass). Similarly, B#3 raster line of the first pass and the A#4 raster line of the first pass are superimposed by the A#3 raster line of the second pass and B#3 raster line of the second pass, respectively. Consequently, when the second pass is completed, the raster lines in which the row A raster lines and the row B raster lines are alternately superimposed are formed, thereby forming an image in which colors of the rows A and colors of the rows B are properly superimposed (which can be seen from the fact that all the area is cross-hatched (with lower left to upper right diagonal lines and upper left to lower right diagonal lines) as shown in the upper right figure).

The lower figures which show an example where a problem has occurred will be described below. The lower left figure is the same as the upper left figure, and the lower left figure shows that the first pass has been made, that is, raster lines are formed during the first pass in which ink is ejected from the nozzles. Similarly to the upper left figure, the row A raster lines and the row B raster lines are alternately arranged in the row direction (front-back direction) with intervals of 1/360 inch in the first pass.

Then, the controller 110 displaces the head 30 in the row direction (front-back direction) by 1/360 inch before executing the second pass. It should be noted that a time lag exists between the first and the second passes. During such a time lag, a sheet of paper may expand and/or contract, which leads to a problem.

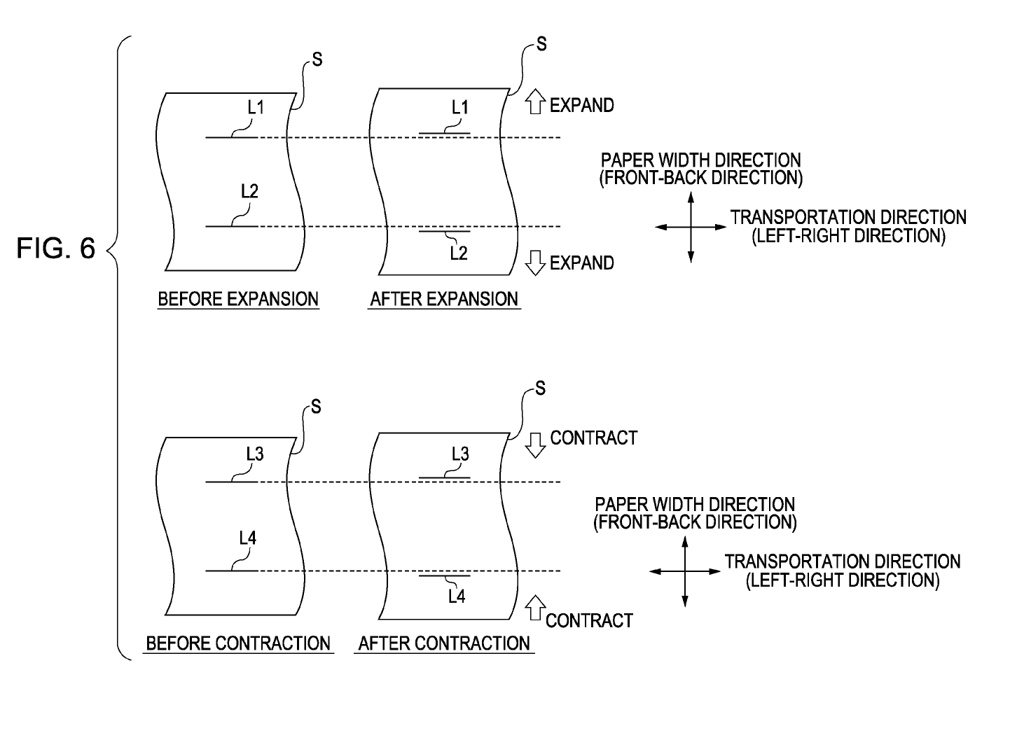

Such expansion and/or contraction of a sheet of paper will be explained with reference to FIG. 6. FIG. 6 is a conceptual view showing that the continuous paper sheet S expands and/or contracts in a sheet width direction.

As a matter of course, the continuous paper sheet S may expand and/or contract due to factors such as changes in temperature of the atmosphere (particularly, more significant expansion and/or contraction of the continuous paper sheet S occurs in this embodiment, since the continuous paper sheet S is actively heated by the platen 17 which is heated by the heater unit 31). The continuous paper sheet S may expand and/or contract in both directions of the transportation direction (the left-right direction) and the sheet width direction (the front-back direction) which is perpendicular to the transportation direction. In this section, the description will be made focusing on the expansion and/or contraction in the sheet width direction.

As shown in the upper figures of FIG. 6, in the case where the continuous paper sheet S expands in the sheet width direction (from the upper left figure to the upper right figure), it is a known fact that the upper part of the continuous paper sheet S with respect to the center in the sheet width direction upwardly expands and the lower part downwardly expands. As the continuous paper sheet S expands, the raster lines formed on the continuous paper sheet S are accordingly displaced. That is, as shown in the upper right figure, the raster line in the upper part (denoted as L1) is upwardly displaced and raster line in the lower part (denoted as L2) is downwardly displaced. As a result, positions of the raster lines in the absolute coordinates are displaced in the front-back direction.

On the other hand, when the continuous paper sheet S contracts in the sheet width direction, a similar problem occurs. That is, in the case where the continuous paper sheet S contracts in the sheet width direction (from the lower left figure to the lower right figure), it is a known fact that the upper part of the continuous paper sheet S with respect to the center in the sheet width direction downwardly contracts and the lower part upwardly contracts. As the continuous paper sheet S contracts, the raster lines formed on the continuous paper sheet S are accordingly displaced. That is, as shown in the lower right figure, the raster line in the upper part (denoted as L3) is downwardly displaced and raster line in the lower part (denoted as L4) is upwardly displaced. As a result, positions of the raster lines in the absolute coordinates are displaced in the front-back direction.

Reference is again made to FIG. 5. As mentioned above, a time lag exists between the first and the second passes. The expansion and/or contraction of a sheet of paper which is shown in FIG. 6 may occur during such a time lag. The lower middle figure shows the raster lines immediately before the second pass. The lower middle figure shows that the expansion and/or contraction of a sheet of paper occurs between the first and the second passes (after the completion of the first pass and before the start of the second pass) and the raster lines which have been formed during the first pass is downwardly displaced. That is, positions of the raster lines which have been made during the first pass in the absolute coordinates are displaced in the front-back direction immediately before the second pass (the displacement is shown exaggerated for clarity in the lower figures in FIG. 5).

Then, the lower right figure shows that the second pass has been executed. That is, the lower right figure shows the raster lines are formed during the second pass in which ink is ejected from the nozzles. Since the head 30 is displaced in the row direction (front-back direction) by 1/360 inch in the second pass, A#3 raster line of the first pass is superimposed by the B#2 raster line of the second pass. However, in this case, the position of A#3 raster line of the first pass in the front-back direction is slightly displaced due to the expansion and/or contraction of the continuous paper sheet S as mentioned above. As a result, unlike the example shown in FIG. 5, areas where adjacent raster lines are not superimposed with each other are formed. The same applied to superimposition between B#3 raster line of the first pass and A#3 raster line of the second pass, and superimposition between A#4 raster line of the first pass and B#3 raster line of the second pass. As a consequence, after the second pass is completed, small areas where color of the row A and color of the rows B are not superimposed are formed in the resultant image. For example, the unsuperimposed areas include an area Pa in which only the ink from the row A is present (which is shown in the lower right figure as the area hatched with lower left to upper right diagonal lines, rather than cross-hatched) and an area Pb in which only the ink from the row B is present (which is shown in the lower right figure as the area hatched with upper left to lower right diagonal lines, rather than cross-hatched). The areas Pa and Pb cause unevenness of the colors in the resultant image.

### The Effectiveness of the Printer According to the Embodiment

As mentioned above, the area in which only the ink from the row A is present and the area in which only the ink from the row B is present may cause unevenness of the colors in the resultant image. To overcome this disadvantage, the inventor thoroughly examined the problem and found a solution to minimize the effect of the unevenness of colors, which will be described below.

The inventor noticed that there is a choice of allocation of the nozzles (to either of the rows A or the rows B) and studied to determine the optimal allocation of the following nozzle rows to either of the rows A or the rows B so as to minimize the effect of the unevenness of colors: the yellow nozzle row, the magenta nozzle row, the cyan nozzle row, the black nozzle row (in this embodiment, the photo black (Pk) nozzle row and the matte black (Mk) nozzle row) and the secondary color nozzle row (in this embodiment, the orange (Or) nozzle row and the green (Gr) nozzle row).

The inventor found that the following allocation is effective and allocated the above nozzle rows according to the invented allocation in this embodiment.

Specifically, a group of rows A composed of a plurality of rows A and a group of rows B composed of a plurality of rows B both satisfy one of the following requirements (1) through (3): (1) the black nozzle row is included, (2) the yellow nozzle row, the magenta nozzle row and the cyan nozzle row are all included, and (3) the secondary color nozzle row for the secondary color made by mixing any two of yellow, magenta and cyan, and at least one of the nozzle row that ejects ink of the remaining one of yellow, magenta and cyan onto the continuous paper sheet S and the secondary color nozzle row for the secondary color which includes the remaining one of yellow, magenta and cyan are included.

The effectiveness of the above-mentioned allocation will be described below. When the group of rows A composed of the plurality of rows A satisfies one of the requirements (1), (2) and (3), the raster lines formed by ejecting ink from the nozzles of the plurality of rows A is black color. Specifically, when the group of rows A satisfies the requirement (1), the group of rows A includes the black nozzle row, resulting in the raster lines of black color being formed, as a matter of course. When the group of rows A satisfies the requirement (2), the yellow ink, magenta ink and cyan ink are superimposed, resulting in the raster lines of black color being formed. When the group of rows A satisfies the requirement (3), similarly to the requirement (2), the yellow ink, magenta ink and cyan ink are superimposed, resulting in the raster lines of black color being formed. The same applies to the group of rows B which satisfies one of the requirements (1), (2) and (3). Accordingly, both the raster lines formed by ejecting ink from the nozzles of the plurality of rows A and the raster lines formed by ejecting ink from the nozzles of the plurality of rows B are black color. With this configuration, the above-mentioned raster lines are superimposed with each other in the printed image. Moreover, in the case where areas in which only the ink from the row A is present (for example, the area Pa) and areas in which only the ink from the row B is present (for example, the area Pb) are formed in the printed image due to expansion and/or contraction of the sheet of paper, both areas (the areas Pa and Pb) appear as a similar type of color, thereby minimizing the effect of the unevenness of colors (in addition to that, the above-mentioned color is a dark color, which minimizes the effect of the unevenness of colors).

In this embodiment, the group of rows A satisfies the requirement (2), since the group of rows A is composed of the yellow (Y) nozzle row, the cyan (C) nozzle row, the clear (Op) nozzle row and the magenta (M) nozzle row, while the group of rows B satisfies the requirements (1) and (3), since the group of rows B is composed of the green (Gr) nozzle row, the photo black (Pk) nozzle row, the orange (Or) nozzle row and the matte black (Mk) nozzle row. That is, both the group of rows A and the group of rows B satisfy one of the requirements (1) through (3).

For a comparison example, if the green (Gr) nozzle row and the magenta (M) nozzle row are replaced with each other, that is, the group of rows A is composed of the yellow (Y) nozzle row, the cyan (C) nozzle row, the clear (Op) nozzle row and the green (Gr) nozzle row, while the group of rows B is composed of the magenta (M) nozzle row, the photo black (Pk) nozzle row, the orange (Or) nozzle row and the matte black (Mk) nozzle row, the group of rows A does not satisfy any of the requirements (1) through (3). In this comparison example, the area Pa appears as green, which is different type of color from that of the area Pb, resulting in the unevenness of the colors being noticeable.

On the contrary, according to this embodiment, since both the group of rows A and the group of rows B satisfy one of the requirements (1) through (3) as mentioned above, both areas (the areas Pa and Pb) appear as a similar type of color, thereby minimizing the effect of the unevenness of colors. Accordingly, the printer 11 according to this embodiment is capable of reducing the deterioration of image quality.

### Other Embodiments

Although the foregoing embodiment is described mainly a liquid ejecting apparatus, other disclosures such as a liquid ejecting method are also included in the invention. The foregoing embodiment is described to facilitate understanding of the invention and is not intended to limit the interpretation of the invention. Various modifications and improvements can be made to the invention without departing from the spirit of the invention, and needless to say, the equivalents are included within the scope of the invention. Specifically, the following embodiments are also included within the scope of the invention.

Although the recording apparatus is embodied as an ink jet printer in the foregoing embodiment, a liquid ejecting apparatus that ejects liquid other than ink may be used. The invention may be applied to various liquid ejecting apparatuses having a liquid ejecting head or the like that ejects fine liquid droplets. It should be noted that the liquid droplets means a state of liquid that is ejected from the liquid ejecting apparatuses and are intended to include those in a particle, tear drop or string shape. Further, the liquid as described herein may be any material that can be ejected from liquid ejecting apparatuses. For example, it may include a material in liquid phase such as liquid having high or low viscosity, sol, gel water, other inorganic solvent, organic solvent and liquid solution, and a material in melted state such as liquid resin and liquid metal (molten metal). Further, in addition to a material in a liquid state, it may include particles of functional material made of solid substance such as pigment and metal particles, which is dissolved, dispersed or mixed in a solvent. Further, typical examples of liquid include ink as mentioned above, liquid crystal and the like. The ink as described herein includes various liquid components such as general water-based ink, oil-based ink, gel ink and hot melt ink. Specific examples of liquid ejecting apparatus may include, for example, liquid ejecting apparatuses that eject liquid containing materials such as electrode material and color material in a dispersed or dissolved state, which are used for manufacturing of liquid crystal displays, EL (electroluminescence) displays, surface emitting displays or color filters, liquid ejecting apparatuses that eject bioorganic materials used for manufacturing biochips, liquid ejecting apparatuses that are used as a precision pipette and eject liquid of a sample, textile printing apparatuses and micro dispensers. Further, examples of fluid ejecting apparatus may also include liquid ejecting apparatuses that eject lubricant to precision instrument such as a clock or camera in a pinpoint manner, liquid ejecting apparatuses that eject transparent resin liquid such as ultraviolet cured resin onto a substrate for manufacturing of minute hemispheric lenses (optical lenses) used for optical communication elements or the like, and liquid ejecting apparatuses that eject acid or alkali etching liquid for etching a substrate or the like. The invention may be applied to any of the above-mentioned liquid ejecting apparatuses.

Further, although the platen 17 in the foregoing embodiment is described as a member that supports and heats the continuous paper sheet S in a state of contact with the continuous paper sheet S, the platen is not limited to this embodiment. For example, the platen may not heat the continuous paper sheet S.

However, the continuous paper sheet S is actively heated by the platen 17 in the configuration of the foregoing embodiment, which causes the continuous paper sheet S to expand and/or contract to a significant extent, resulting in the above-mentioned unevenness of the colors being more likely to occur. Therefore, the foregoing embodiment is more effective in that the above-mentioned effectiveness, by which the effect of the unevenness of colors is minimized and the deterioration of image quality is reduced, is more effectively achieved.

What is claimed is:

1. A liquid ejecting apparatus having a head which is provided with a plurality of first nozzle rows composed of nozzles arranged at corresponding positions in the row direction in all the plurality of first nozzle rows and a plurality of second nozzle rows composed of nozzles arranged at corresponding positions in the row direction in all the plurality of second nozzle rows and offset in the row direction from the nozzle positions of the plurality of first nozzle rows, each of the plurality of first nozzle rows and the plurality of second nozzle rows including different nozzle rows selected from a first color nozzle row that ejects a first primary color liquid onto a medium, a second color nozzle row that ejects a second primary color liquid onto the medium, a third color nozzle row that ejects a third primary color liquid onto the medium, a black nozzle row that ejects a black liquid onto the medium, and a secondary color nozzle row that ejects at least one secondary color liquid onto the medium, the liquid ejecting apparatus comprising:
a group of first nozzle rows composed of the plurality of first nozzle rows and a group of second nozzle rows composed of the plurality of second nozzle rows, wherein both the group of first nozzle rows and the group of second nozzle rows satisfying one of the following requirements (1) through (3):
(1) the black nozzle row is included,
(2) a yellow nozzle row, a magenta nozzle row and a cyan nozzle row are all included, and
(3) the secondary color nozzle row for the secondary color made by mixing any two of yellow, magenta and cyan, and at least one of the nozzle row that ejects liquid of the remaining one of yellow, magenta and cyan onto the medium and the secondary color nozzle row for the secondary color which includes the remaining one of yellow, magenta and cyan are included.

2. The liquid ejecting apparatus according to claim 1, further comprising a support member that supports and heats the medium in a state of contact with the medium.

3. The liquid ejecting apparatus according to claim 1, wherein the first color is yellow, the second color is magenta, and the third color is cyan.

4. A liquid ejecting method for ejecting liquid onto a medium for use with a liquid ejecting apparatus having a head which is provided with a plurality of first nozzle rows composed of nozzles arranged at corresponding positions in the row direction in all the plurality of first nozzle rows and a plurality of second nozzle rows composed of nozzles arranged at corresponding positions in the row direction in all the plurality of second nozzle rows and offset in the row direction from the nozzle positions of the plurality of first nozzle rows, each of the plurality of first nozzle rows and the plurality of second nozzle rows including different nozzle rows selected from a first color nozzle row that ejects a first primary color liquid onto the medium, a second color nozzle row that ejects a second primary color liquid onto the medium, a third color nozzle row that ejects a third primary color liquid onto the medium, a black nozzle row that ejects a black liquid onto the medium, and a secondary color nozzle row that ejects at least one secondary color liquid onto the medium, the liquid ejecting apparatus including a group of first nozzle rows composed of the plurality of first nozzle rows and a group of second nozzle rows composed of the plurality of second nozzle rows, wherein both the group of first nozzle rows and the group of second nozzle rows satisfying one of the following requirements (1) through (3):
(1) the black nozzle row is included,
(2) a yellow nozzle row, a magenta nozzle row and a cyan nozzle row are all included, and
(3) the secondary color nozzle row for the secondary color made by mixing any two of yellow, magenta and cyan, and at least one of the nozzle row that ejects liquid of the remaining one of yellow, magenta and cyan onto the medium and the secondary color nozzle row for the secondary color which includes the remaining one of yellow, magenta and cyan are included.

5. The liquid ejecting method according to claim 4, wherein the first color is yellow, the second color is magenta, and the third color is cyan.
